(19) United States
(12) Patent Application Publication
(10) Pub. No.: US 2023/0385453 A1
(43) Pub. Date: Nov. 30, 2023

(54) MANAGING DIGITAL RIGHTS IN A COMPUTERIZED ENVIRONMENT

(71) Applicant: ITsMine Ltd., Herzliya (IL)

(72) Inventors: Ran NORMAN, Rishon LeZion (IL); Kfir KIMHI, Herzliya (IL); Guy BEN MAYOR, Rishon LeZion (IL)

(73) Assignee: ITsMine Ltd., Herzliya (IL)

(21) Appl. No.: 18/326,134

(22) Filed: May 31, 2023

Related U.S. Application Data
(60) Provisional application No. 63/365,564, filed on May 31, 2022.

(51) Int. Cl. G06F 21/62; G06F 21/55

(52) U.S. Cl. CPC G06F 21/6272; G06F 21/554

(57) ABSTRACT

A system and method for securing computerized environments using digital rights management. A method includes applying a security policy to a folder in a computerized environment such that the security policy is enforced on each file of the folder; associating a deactivation rule to each of at least one file deployed in the folder based on the security policy, wherein the deactivation rule associated with each file defines a time period with respect to the file after which the file expires; and associating each of the at least one file with a unique identifier, wherein the unique identifier is periodically updated while each of the at least one file is stored in the folder, wherein the security policy is enforced on the at least one file based on the respective unique identifier associated with each of the at least one file.

### CROSS-REFERENCE TO RELATED APPLICATIONS

This application claims the benefit of U.S. Provisional Application No. 63/365,564 filed on May 31, 2022, the contents of which are hereby incorporated by reference.

### TECHNICAL FIELD

The present disclosure generally relates to data security, and more specifically to a system and method for managing digital rights in a computer-based system.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for securing computerized environments using digital rights management. The method comprises: applying, by a computerized digital rights manager, a security policy to a folder in a computerized environment such that the security policy is enforced on each file of the folder; associating, by the computerized digital rights manager, a deactivation rule to each of at least one file deployed in the folder based on the security policy, wherein the deactivation rule associated with each file defines a time period with respect to the file after which the file expires; and associating, by the computerized digital rights manager, each of the at least one file with a unique identifier, wherein the unique identifier is periodically updated while each of the at least one file is stored in the folder, wherein the security policy is enforced on the at least one file based on the respective unique identifier associated with each of the at least one file.

Certain embodiments disclosed herein also include a non-transitory computer readable medium having stored thereon causing a processing circuitry to execute a process, the process comprising: applying, by a computerized digital rights manager, a security policy to a folder in a computerized environment such that the security policy is enforced on each file of the folder; associating, by the computerized digital rights manager, a deactivation rule to each of at least one file deployed in the folder based on the security policy, wherein the deactivation rule associated with each file defines a time period with respect to the file after which the file expires; and associating, by the computerized digital rights manager, each of the at least one file with a unique identifier, wherein the unique identifier is periodically updated while each of the at least one file is stored in the folder, wherein the security policy is enforced on the at least one file based on the respective unique identifier associated with each of the at least one file.

Certain embodiments disclosed herein also include a system for securing computerized environments using digital rights management. The system comprises: a processing circuitry; and a memory, the memory containing instructions that, when executed by the processing circuitry, configure the system to: apply, by a computerized digital rights manager, a security policy to a folder in a computerized environment such that the security policy is enforced on each file of the folder; associate, by the computerized digital rights manager, a deactivation rule to each of at least one file deployed in the folder based on the security policy, wherein the deactivation rule associated with each file defines a time period with respect to the file after which the file expires; and associate, by the computerized digital rights manager, each of the at least one file with a unique identifier, wherein the unique identifier is periodically updated while each of the at least one file is stored in the folder, wherein the security policy is enforced on the at least one file based on the respective unique identifier associated with each of the at least one file.

### BRIEF DESCRIPTION OF THE DRAWINGS

The subject matter that is regarded as the disclosure is particularly pointed out and distinctly claimed in the claims at the conclusion of the specification. The foregoing and other objects, features, and advantages of the disclosure will be apparent from the following detailed description taken in conjunction with the accompanying drawings.

FIG. 1 is a network diagram utilized to describe various disclosed embodiments.

FIG. 2 is an example schematic diagram of a digital rights manager according to an embodiment.

FIG. 3 is a flowchart illustrating a process for managing digital rights in a computer-based environment according to an embodiment.

FIG. 4 is a flowchart illustrating a process for automatically applying security policies to files according to an embodiment.

### DETAILED DESCRIPTION

It is important to note that the embodiments disclosed by the present disclosure are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

A system and method for managing digital rights in a computerized environment. A method includes: applying, by a computerized digital rights manager, a first security policy for a first folder to be applied on each file of the first folder, the first folder is located in the computerized environment; associating, by the computerized digital rights manager, a first deactivation rule to the each file of the first folder based on the first security policy, the first deactivation rule facilitates expiration of the each file after a predetermined time duration; and, associating, by the computerized digital rights manager, the each file of the first folder with a unique identifier, wherein the unique identifier is periodically updated while the each file is stored in the first folder.

The disclosed embodiments provide techniques which utilize improved granularity security policies in order to protect organizational infrastructures from potential cybersecurity threats in the form of data breaches. More specifically, policies are applied at the file level through the folders in which those files are stored. By enforcing policies at the file level across folders, enforcement can be streamlined in a manner which allows for more efficient mitigation of potential cyber threats.

The disclosed embodiments further include various techniques for managing policies with respect to files based on time of deployment that prevents files from being “grandfathered in” to outdated policies and ensuring that current policies are enforced on more recent files without needing to manually or otherwise individually configure files per policy. This, in turn, allows for efficiently deploying files and enforcing security policies with respect to individual files while maximizing security of the computing environment having the folders in which the files are deployed.

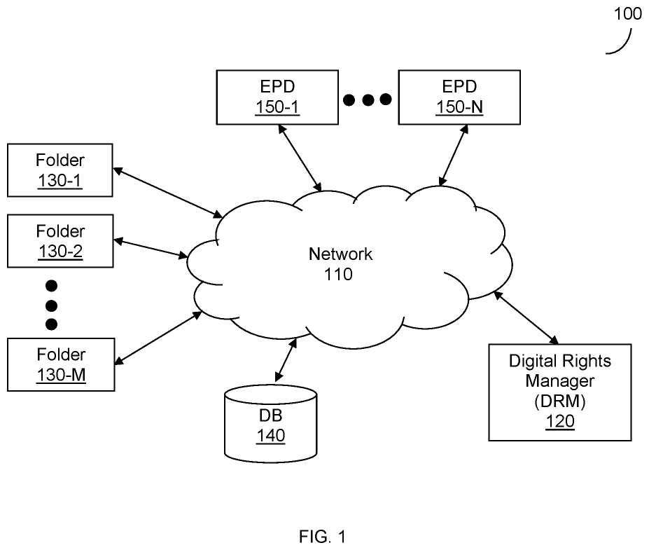

FIG. 1 depicts a network diagram 100 utilized to describe various disclosed embodiments. A network 110 is used to enable communication between the different components of the network diagram 100. The network 110 may be, but is not limited to, a local area network (LAN), a wide area network (WAN), a metro area network (MAN), the world wide web (WWW), the Internet, a wired network, a wireless network, and the like, as well as any combination thereof.

A computerized digital rights manager (DRM) 120 is connected to the network 110. The DRM 120 may be configured to execute predetermined computing tasks. The DRM 120 includes a processing circuitry 210 and a memory 215, as further described herein below.

At least one folder 130, such as the folders 130-1 through 130-M (where M is an integer equal to or greater than 1), is communicatively connected to the network 110. The folders 130 may be stored in a computer-based environment, a cloud-based environment, a local database, and so on.

A database 140 may also be connected to the network 110. The database 140 is configured to store, for example, data related to one or more security policies, rules, and so on.

A plurality of end point devices (EPD) 150-1 through 150-N (where N is an integer equal to or greater than 1) are communicatively connected to the network 110. The EPDs 150 can be, but are not limited to, smart phones, mobile phones, laptops, tablet computers, wearable computing devices, personal computers (PCs), a combination thereof, and the like.

In an embodiment, the DRM 120 is configured to apply a first security policy for a first folder (e.g., the folder 130-1) to be applied on each file (not shown) of the first folder. The first folder is located in the computerized environment. The DRM 120 is further configured to associate a first deactivation rule to each file of the first folder based on the first security policy. The first deactivation rule facilitates expiration of each file after a predetermined time duration. The DRM 120 is further configured to associate each file of the first folder (e.g., the folder 130-1) with a unique identifier. The unique identifier is periodically updated while the file is stored in the first folder (e.g., the first folder 130-1). The unique identifier may be used by the DRM 120 for the purpose of extracting metadata about a file that was initially stored in the first folder and, thereafter, triggered by a first entity as further discussed herein below.

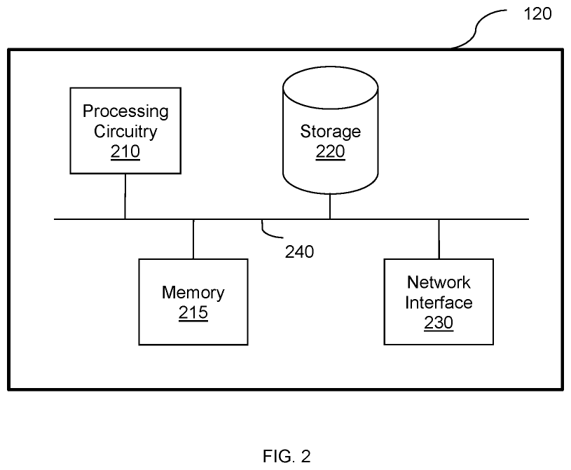

FIG. 2 is an example schematic diagram of the computerized digital rights manager (DRM) 120 according to an embodiment. The DRM 120 includes a processing circuitry 210 coupled to a memory 215, a storage 220, and a network interface 230. In another embodiment, the components of the DRM 120 may be connected via a bus 240.

The processing circuitry 210 may be realized as one or more hardware logic components and circuits. For example, and without limitation, illustrative types of hardware logic components that can be used include one or more field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), GPUs, and the like, or any other hardware logic components that can perform manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein.

The storage 220 may be magnetic storage, optical storage, and the like, and may be realized, for example, as flash memory, or any other medium which can be used to store the desired information.

The network interface 230 allows the DRM 120 to communicate with at least the folders 130 (and files), the database 140 and the EPDs 150 over a network (e.g., the network 110), all of FIG. 1, for the purpose of, for example, applying security policies to one or more folders, associate files of the folders with unique identifiers, receive electronic indication from files which were triggered, and the like.

It should be understood that the embodiments described herein are not limited to the specific architecture illustrated in FIG. 2, and other architectures may be equally used without departing from the scope of the disclosed embodiments.

Returning to FIG. 1, in an embodiment, the DRM 120 applies a first security policy for a first folder 130-1 to be applied on each file of the first folder 130-1, each subfolder(s) of the first folder 130-1, or both. The first folder 130-1 is located in a computerized environment which may be, for example but not limited to, a local storage, a cloud-based environment, and the like.

The first security policy is a set of rules indicating permissions, restrictions, or both, regarding all the files that are stored in a specific folder (e.g., the folder 130-1), or file(s) stored in a subfolder(s) of the first folder (e.g., the folder 130-1). The rules of the first security policy may determine, for example and without limitation, that a first group of users (e.g., a group of users corresponding to a group of employees within an organization) has full read and write permissions, that a second group of users has view-only permissions, that users outside the organization are not allowed to access (e.g., to open, copy, etc.) the files, that all files stored in the folder should be deactivated 3 days after each file is triggered (e.g., opened, copied, downloaded, etc.) by any entity, and so on.

In an embodiment, a file is triggered when a trigger condition is met with respect to the file. In a further embodiment, the trigger condition is a condition requiring a certain kind of interaction or combination of interactions with the file such as, but not limited to, opening the file, copying the file, downloading the file, and the like. The trigger condition may be defined in the security policy such that, when the security policy is enforced on the file, the file is triggered and an electronic indication may be generated when the trigger condition is met. Moreover, the trigger conditions may be defined with respect to specific users or types of users (e.g., users belonging to a certain group, having certain access permissions, or otherwise having certain predetermined characteristics). A file may be said to be triggered by an entity when the trigger condition is met via an interaction of the entity with the file.

In an embodiment, the same security policy is applied to all files that are stored in the first folder and to the files stored in a subfolder(s) of the first folder. According to different embodiments of this disclosure, each folder 130 to which a security policy is applied may include a single file, a plurality of files, one or more subfolders, or no files at all. A subfolder of one of the folders 130 may be, but is not limited to, a folder within the folder 130, a subfolder of a folder within the folder 130, and so on, without any loss of generality. That is, a subfolder may be a subfolder directly of the folder 130 or a nested subfolder within one or more other subfolders of the folder 130. When no files are stored in the folder, the security policy is still applied to the folder 130 such that when a new file is added to the folder 130, the first security policy is applied to the new file.

It should be noted that different security policies may be applied to different folders. That is, a first security policy, having a first set of permissions and restrictions, may be applied to a first folder, and a second security policy, having a second set of permissions and restrictions, may be applied to a second folder.

In an embodiment, the DRM 120 associates a first deactivation rule to each file of the first folder 130-1. It should be noted that the first deactivation rule may be associated with an existing file, a plurality of existing files, a new file(s) added to the first folder, file(s) stored in existing and/or new subfolder(s) of the first folder, and so on.

In an embodiment, the security policy may indicate the first deactivation rule which determines the time duration of the files. The first deactivation rule facilitates expiration of each file after a predetermined time duration such as, but not limited to, a predetermined time period since an event related to the file. In an embodiment, the first deactivation rule may define a time period with respect to triggering or deployment of the file such that each file associated with the deactivation rule expires after that time period has passed since that file was triggered or deployed. In other words, events related to the file may be or may include, but are not limited to, triggering of a file, deployment of file, or both.

The deactivation rule may be implemented as an algorithm or a sequence of instructions causing the files to expire after a predetermined duration. For example, a deactivation rule may determine that each file stored in the folder 130, which is triggered (opened, copied, downloaded, etc.) by an entity, should be expired within 10 days from the day it was triggered, and therefore after 10 days it will be impossible to use the file. It should be noted that the same deactivation rule applies to all files stored at the same folder.

In a further embodiment, the DRM 120 may be configured to periodically update the deactivation rule and the time duration after which a triggered file will be deactivated (i.e., expired). It should be noted that the deactivation rule of a file is periodically updated while the file is stored in the first folder. For example and without limitation, the DRM 120 may update the deactivation rule and the time duration of each file stored in the first folder, every 24 hours.

In an embodiment, the DRM 120 associates each file of the first folder 130 with a unique identifier. The unique identifier is a unique sequence of, for example, digits, letters, or a combination thereof. The unique identifier associated with each file is periodically updated while the file is stored in the first folder 130. For example, the unique identifier may be updated every day, every 12 hours, every one hour, and the like, while the files are stored in the folder.

Periodically updating the unique identifier allows for facilitating an effective and fast tracking of a triggered file which was initially stored at the first folder and thereafter triggered (e.g., opened, copied, downloaded, etc.) by a certain entity, as further discussed below.

In an embodiment, the unique identifiers may be associated with files such that the files can be identified, for example, for purposes of enforcing security policies (e.g., a first security policy of a first folder in which each file is deployed). In this regard, in some embodiments, security policies are applied to files based on their respective unique identifiers. More specifically, certain events may trigger conditions in security policies for certain files (identified via their respective unique identifiers), for certain entities attempting to access certain files, both, and the like. This, in turn, allows for more quickly and efficiently preventing potential cyber threats by allowing for applying security policies with respect to the files associated with the respective unique identifiers (e.g., a first security policy of a first folder in which those files are deployed).

In an embodiment, the DRM 120 receives an electronic indication from a first file that was triggered (e.g., opened, copied, downloaded, etc.) by a first entity using, for example, an end-point device of the entity. The entity may be, for example, an external user (i.e., not related to the organization), an employee, department, and the like. It should be noted that the file may be triggered by an end-point device that is associated with a user, an employee, a department, and the like. In an embodiment, the electronic indication includes at least the unique identifier. It should be noted that each file of the files that are stored in the folder 130 may be previously configured to send an electronic indication to the DRM 120 after being triggered.

The DRM 120 may be configured to extract metadata related to the triggered first file using the unique identifier. The metadata may include, for example and without limitation, the time at which the file was triggered (e.g., the time at which the file was opened, copied, downloaded, and the like), an Internet Protocol (IP) address of the device who triggered the file, the folder at which the file was stored, the file name, file type, file size, and so on. The metadata may be extracted from a log file, a local storage, a database (e.g., the database 140), and so on.

In an embodiment, the metadata indicates one or more circumstances related to the triggering of the first file such as, but not limited to, the time of triggering, an identifier of the entity that triggered the file (e.g., an IP address or other identifier of a device used by the entity, or an identifier of an account of the entity through which the entity interacted with the first file), and the like. In a further embodiment, the metadata may also indicate the unique identifier of the triggered file.

The DRM 120 may be configured to generate an electronic alert which includes at least a portion of the metadata. The electronic alert may be an electronic message indicating, for example and without limitation, the triggered file name, the time at which the file was downloaded, the user's name (e.g., an employee acting as a user) or other identifier that is associated with an end-point device which was used for downloading the file, the folder at which the file was initially stored, the file type, and so on. In a further embodiment, the DRM 120 sends the electronic alert to at least one predetermined computing device. For example, the electronic alert may be sent to an end-point device (e.g., the EPD 150) of a security department of the organization, to a predetermined email address, to a security information and event management (SIEM) system, to an EPD 150 that is associated with the user who triggered the file, and the like.

In an embodiment, the DRM 120 applies the first security policy to each new file that is deployed to the first folder, for example, each file that is added to or created in the first folder, or added to or created in a subfolder(s) of the first folder. That is, the first security policy is automatically applied to each new file that is added to the first folder and therefore, it is unnecessary to associate each file with a specific security policy. As noted above, different folders may have different security policies such that, when a file is added to a specific folder (i.e., stored within a folder), the security policy which applies to the folder is automatically applied to the newly added file. Thus, it is easier and much less complicated and time consuming to keep the organization safe from data breaches by applying predetermined security policies to folders which automatically apply their security policies to the files.

In an embodiment, after a file is triggered (downloaded, copied, and the like) and the predetermined time duration of the file ends, the file is expired and cannot be used any more. However, in at least some embodiments, the user can upload the file to the folder (e.g., the first folder 130-1) at which the file was originally stored, and the uploaded file may be added to or otherwise deployed in the folder in order to get a new time duration for the uploaded file, based on the most updated deactivation rule of the folder, which applies to all files stored in that folder in case the user still wants to use the file, i.e., if the user still wants to use the file, a new time duration may be assigned for that file, and the new time duration may be subject to the current deactivation rule instead of the original deactivation rule.

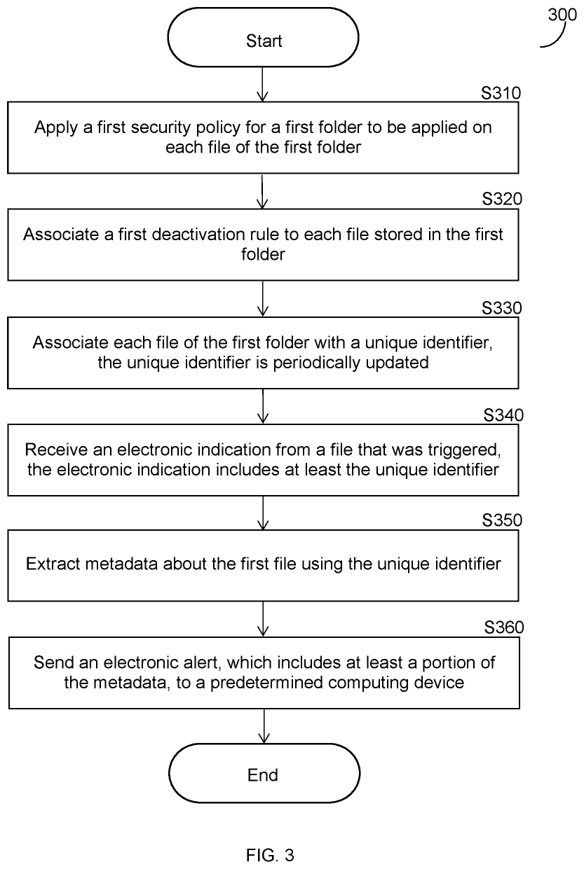

FIG. 3 is an example flowchart 300 illustrating a process of digital rights management according to an embodiment. In an embodiment, the process of FIG. 3 is executed by the computerized digital rights manager (DRM) 120 of FIG. 2.

At S310, a first security policy is applied to a first folder (e.g., the folder 130-1 of FIG. 1) such that the first security policy is enforced on each file of the first folder and to any file stored in a subfolder of the first folder. The first folder is located in a computerized environment which may be, for example but not limited to, a local storage, a cloud-based environment, and the like. The first security policy is a set of rules indicating permissions, restrictions, or both, regarding all the files that are stored in a specific folder.

At S320, a first deactivation rule is associated with each file of the first folder (e.g., the folder 130-1 of FIG. 1). In an embodiment, each file of the first folder is a file stored in the first folder, either in the first folder itself or in a subfolder of the first folder. In an embodiment, the security policy may indicate the first deactivation rule which determines the time duration of the files.

The deactivation rule facilitates expiration of each file after a predetermined time duration. To this end, in an embodiment, the deactivation rule defines a time period after which each associated file expires such that each associated file expires after that time period has passed since the deployment of the file in the first folder (e.g., when the file was created in the first folder or a subfolder of the first folder, or otherwise when the file was moved to the first folder or a subfolder of the first folder). The deactivation rule of a file is periodically updated while the file is stored or otherwise deployed in the first folder.

At S330, each file of the first folder (e.g., the folder 130-1 of FIG. 1) is associated with a unique identifier. The unique identifier is unique sequence of, for example, digits, letters, a combination thereof, and the like. The unique identifier is periodically updated while each file is stored in the first folder. Each unique identifier is unique at least insofar as no two files have the same unique identifier, i.e., the unique identifier of a file is unique to that file (i.e., the respective file to which the unique identifier is associated).

At optional S340, an electronic indication is received from a first file that was triggered (opened, copied, downloaded, etc.) by a first entity using, for example, an end-point device of the entity. The entity may be, for example a user, employee, department, and the like. The electronic indication includes at least the unique identifier.

At optional S350, metadata related to the triggered first file is extracted using the unique identifier. The metadata may include, for example and without limitation, the time at which the file was triggered (opened, copied, downloaded, and the like), the IP address of the device who triggered the file, the folder at which the file was stored, the file name, file type, file size, and so on.

At optional S360, an electronic alert, which includes at least a portion of the extracted metadata, is sent to at least one predetermined computing device, thereby indicating to the at least one predetermined computing device that the file was triggered. For example, the electronic alert may be sent to an end-point device (e.g., one of the EPDs 150 of FIG. 1) of a security department of the organization, to an end-point device that is associated with the entity (e.g., a user) who triggered the file, both, and the like. In a further embodiment, S360 may also include generating the electronic alert.

In some embodiments, the at least one predetermined computing device is configured to perform one or more mitigation actions with respect to the triggered first file based on the electronic alert (e.g., based on the circumstances of the triggering indicated in the metadata or portion of metadata included in the electronic alert), thereby efficiently securing a computing environment in which the file is deployed from potentially malicious activity with respect to the file. To this end, in a further embodiment, the electronic alert may also indicate the unique identifier of the at least one file.

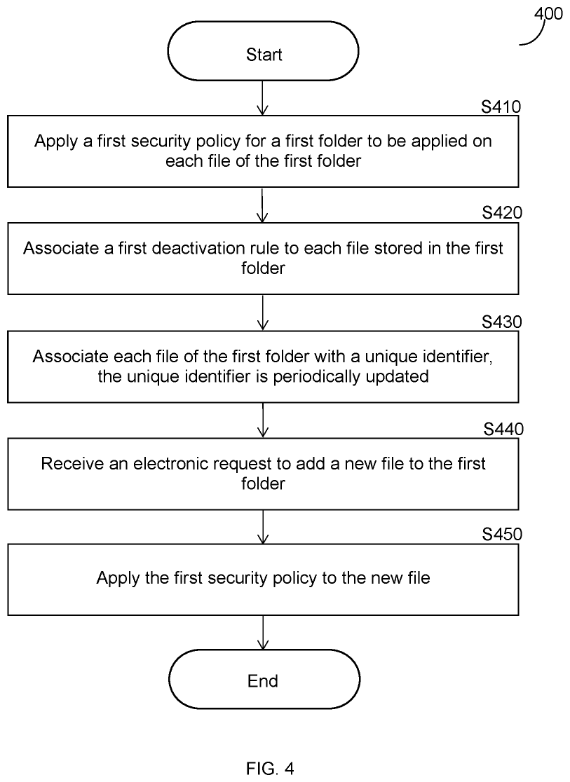

FIG. 4 is an example flowchart 400 illustrating a process of automatically applying security policies to files according to an embodiment. The process described herein below may be executed by the computerized digital rights manager (DRM) 120 of FIG. 2.

At S410, a first security policy is applied to a first folder (e.g., the folder 130-1 of FIG. 1) such that the first security policy is enforced on each file of the first folder and to any file stored in a subfolder of the first folder. The first folder is located in a computerized environment which may be, for example but not limited to, a local storage, a cloud-based environment, and the like. The first security policy is a set of rules indicating permissions, restrictions, or both, regarding all the files that are stored in a specific folder.

At S420, a first deactivation rule is associated with each file of the first folder (e.g., the folder 130-1 of FIG. 1). In an embodiment, each files of the first folder is a file stored in the first folder, either in the first folder itself or in a subfolder of the first folder. In an embodiment, the security policy may indicate the first deactivation rule which determines the time duration of the files.

The deactivation rule facilitates expiration of each file after a predetermined time duration. To this end, in an embodiment, the deactivation rule defines a time period after which each associated file expires such that each associated file expires after that time period has passed since the deployment of the file in the first folder (e.g., when the file was created in the first folder or a subfolder of the first folder, or otherwise when the file was moved to the first folder or a subfolder of the first folder. The deactivation rule of a file is periodically updated while the file is stored in the first folder.

At S430, each file of the first folder (e.g., the folder 130-1 of FIG. 1) is associated with a unique identifier. The unique identifier is unique sequence of, for example, digit, letters, a combination thereof, and the like. The unique identifier is periodically updated while each file is stored in the first folder. Each unique identifier is unique at least insofar as no two files have the same unique identifier.

At S440, a request for adding a new file to the first folder is received. The request may be generated by, for example, an end-point device (e.g., one of the EPDs 150 of FIG. 1).

At S450, the first security policy of the first folder is applied to the new file which was added to the first folder. In an embodiment, S440 may also include the step of extracting the first security policy of the first folder from, for example, a database (e.g., the database 140 of FIG. 1) such that the first policy can be applied to the new file added to the first folder. Thus, by adding the new file to the first folder, the first security policy of the first folder applies to the new file.

The embodiments disclosed herein can be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

What is claimed is:

1. A method for securing computerized environments using digital rights management, comprising:
applying, by a computerized digital rights manager, a security policy to a folder in a computerized environment such that the security policy is enforced on each file of the folder;
associating, by the computerized digital rights manager, a deactivation rule to each of at least one file deployed in the folder based on the security policy, wherein the deactivation rule associated with each file defines a time period with respect to the file after which the file expires; and
associating, by the computerized digital rights manager, each of the at least one file with a unique identifier, wherein the unique identifier is periodically updated while each of the at least one file is stored in the folder, wherein the security policy is enforced on the at least one file based on the respective unique identifier associated with each of the at least one file.

2. The method of claim 1, wherein the deactivation rule is periodically updated with respect to each of the at least one file while the respective file is deployed in the first folder.

3. The method of claim 1, further comprising:
receiving an electronic indication with respect to a first file of the at least one file that was triggered by an entity, wherein the electronic indication includes at least the unique identifier of the first file;
extracting metadata for the first file using the unique identifier of the first file, wherein the extracted metadata indicates at least one circumstance of triggering of the first file; and
generating an electronic alert which includes at least a portion of the metadata.

4. The method of claim 3, further comprising:
sending the electronic alert to at least one predetermined computing device, wherein the at least one predetermined computing device is configured to perform at least one mitigation action with respect to the triggered first file based on the electronic alert.

5. The method of claim 3, wherein the electronic alert indicates the unique identifier of the first file.

6. The method of claim 1, wherein the at least one file is at least one first file, wherein at least one second file is deployed to the folder such that the security policy is enforced on the at least one second file.

7. The method of claim 1, wherein the time period defined by the deactivation rule associated with each file is defined further with respect to a time since the file is triggered.

8. The method of claim 1, wherein the security policy is a set of rules indicating at least one of restrictions and permissions for each file stored in the folder.

9. The method of claim 1, wherein the unique identifier associated with each file is unique to the respective file.

10. A non-transitory computer readable medium having stored thereon instructions for causing a processing circuitry to execute a process, the process comprising:
applying, by a computerized digital rights manager, a security policy to a folder in a computerized environment such that the security policy is enforced on each file of the folder;
associating, by the computerized digital rights manager, a deactivation rule to each of at least one file deployed in the folder based on the security policy, wherein the deactivation rule associated with each file defines a time period with respect to the file after which the file expires; and
associating, by the computerized digital rights manager, each of the at least one file with a unique identifier, wherein the unique identifier is periodically updated while each of the at least one file is stored in the folder, wherein the security policy is enforced on the at least one file based on the respective unique identifier associated with each of the at least one file.

11. A system for securing computerized environments using digital rights management, comprising:
a processing circuitry; and
a memory, the memory containing instructions that, when executed by the processing circuitry, configure the system to:
apply, by a computerized digital rights manager, a security policy to a folder in a computerized environment such that the security policy is enforced on each file of the folder;
associate, by the computerized digital rights manager, a deactivation rule to each of at least one file deployed in the folder based on the security policy, wherein the deactivation rule associated with each file defines a time period with respect to the file after which the file expires; and
associate, by the computerized digital rights manager, each of the at least one file with a unique identifier, wherein the unique identifier is periodically updated while each of the at least one file is stored in the folder, wherein the security policy is enforced on the at least one file based on the respective unique identifier associated with each of the at least one file.

12. The system of claim 11, wherein the deactivation rule is periodically updated with respect to each of the at least one file while the respective file is deployed in the first folder.

13. The system of claim 11, wherein the system is further configured to:
receive an electronic indication with respect to a first file of the at least one file that was triggered by an entity, wherein the electronic indication includes at least the unique identifier of the first file;
extract metadata for the first file using the unique identifier of the first file, wherein the extracted metadata indicates at least one circumstance of triggering of the first file; and
generate an electronic alert which includes at least a portion of the metadata.

14. The system of claim 13, wherein the system is further configured to:
send the electronic alert to at least one predetermined computing device, wherein the at least one predetermined computing device is configured to perform at least one mitigation action with respect to the triggered first file based on the electronic alert.

15. The system of claim 13, wherein the electronic alert indicates the unique identifier of the first file.

16. The system of claim 11, wherein the at least one file is at least one first file, wherein at least one second file is deployed to the folder such that the security policy is enforced on the at least one second file.

17. The system of claim 11, wherein the time period defined by the deactivation rule associated with each file is defined further with respect to a time since the file is triggered.

18. The system of claim 11, wherein the security policy is a set of rules indicating at least one of restrictions and permissions for each file stored in the folder.

19. The system of claim 11, wherein the unique identifier associated with each file is unique to the respective file.
